(19) United States
(12) Patent Application Publication
(10) Pub. No.: US 2013/0041943 A1
(43) Pub. Date: Feb. 14, 2013

(54) DISTRIBUTION SYSTEM, DISTRIBUTION CONTROL DEVICE, AND DISTRIBUTION CONTROL METHOD

(71) Applicant: Kazunori Ozawa, Tokyo (JP)

(72) Inventor: Kazunori Ozawa, Tokyo (JP)

(73) Assignee: NEC CORPORATION, Tokyo (JP)

(21) Appl. No.: 13/642,011

(22) PCT Filed: Apr. 19, 2011
(86) PCT No.: PCT/JP2011/059601

§ 371 Date: Oct. 18, 2012

(30) Foreign Application Priority Data
Apr. 20, 2010 (JP) 2010-096769

(51) Int. Cl. G06F 15/16

(52) U.S. Cl. 709/203

(57) ABSTRACT

A distribution system includes: a plurality of cache servers that are connected to at least one of a plurality of packet forwarding devices forwarding a packet supplied from a content distribution server and temporarily hold a content; and a distribution control device that stores a content map representing a content held by the each of the plurality of cache servers, extracts, when receiving a request for a content from a terminal, a cache server near the terminal from among the plurality of cache servers based on information about an area in which the terminal exists, and instructs the extracted cache server to transmit the content requested by the terminal.

### TECHNICAL FIELD

### REFERENCE TO RELATED APPLICATION

The present invention is based upon and claims the benefit of the priority of Japanese patent application No. 2010-096769, filed on Apr. 20, 2010, the disclosure of which is incorporated herein in its entirety by reference thereto.

The present invention relates to a distribution system, a distribution control device, and a distribution control method. In particular, it relates to a distribution system, a distribution control device, and a distribution control method for distributing contents such as moving images, still images, audio, software, and applications to terminals such as mobile phones, personal computers (PCs), and game machines via mobile networks.

### BACKGROUND

Along with the increase in the speed and capacity of mobile networks, distribution of contents to mobile terminals via mobile networks is spreading fast.

For example, Long Term Evolution (LTE) and Evolved Packet Core (EPC) technology is expected to further increase the speed and capacity of mobile networks.

Patent Literature 1 discloses a distributed file system that distributes access requests from client computers to a plurality of proxy server computers, to improve throughput. In addition, Patent Literature 2 discloses a digital content delivery system that uses a plurality of cache servers, to reduce server load and network bandwidth requests.
Patent Literature 1: Japanese Patent Kokai Publication No. JP-A10-021134
Patent Literature 2: Japanese Patent Kohyo Publication No. JP-P2005-532748A

### SUMMARY

The entire disclosures of the above Patent Literatures are incorporated herein by reference thereto. The following analyses are made by the present inventor.

By the year 2013, the amount of data traffic is expected to increase more than eight to ten times, and video contents are expected to occupy a large amount of the traffic. In addition, as the capabilities of terminals improve, larger-capacity video contents are appearing. In the near future, high-definition and large-capacity contents are expected to be available through mobile networks.

Meanwhile, currently, when distribution of contents is executed via a mobile network, all the terminals transmit content requests to a content distribution server via packet forwarding devices, and the content delivery server distributes contents to the terminals via the packet forwarding devices. However, this method causes the following problems.

First, if a terminal and the contents delivery server are far away from each other, much time is required for the terminal to receive the content. Namely, since the delay time from a timing at which the terminal transmits a request for the content to a timing at which the terminal reproduces the content is extended, quality of experience (QoE) for the end user is decreased.

Second, if the amount of traffic increases with an increase in the number of terminals and the capacity of contents, distribution capabilities of the content distribution server and forwarding capabilities of the packet forwarding devices cause bottlenecks. As a result, since the traffic in the network is congested and delay or packet loss is caused, the terminals may have image frozen or voice interrupted.

Third, to eliminate these bottlenecks, the above server and devices need to be enhanced constantly, in anticipation of an increase in the number of terminals and the amount of traffic.

Thus, there is a need in the art to provide a distribution system, a distribution control device, and a distribution control method that prevent a decrease of user QoE even when the traffic is increased in a content distribution system.

A distribution system according to a first aspect of the present invention comprises:
a plurality of cache servers that are connected to at least one of a plurality of packet forwarding devices forwarding a packet supplied from a content distribution server and temporarily holds a content; and
a distribution control device that stores a content map representing a content held by each of the plurality of cache servers, extracts, when receiving a request for a content from a terminal, a cache server near the terminal from among the plurality of cache servers based on information about an area in which the terminal exists, and instructs the extracted cache server to transmit the content requested by the terminal.

A distribution control device according to a second aspect of the present invention comprises:
a content map creation and storage unit that stores a content map representing a content held by a plurality of cache servers, each of the plurality of cache servers being connected to at least one of a plurality of packet forwarding devices forwarding a packet supplied from a content distribution server and temporarily holding a content; and
a content acquisition instruction unit extracts, when receiving a request for a content from a terminal, a cache server near the terminal from among the plurality of cache servers based on information about an area in which the terminal exists, and instructs the extracted cache server to transmit the content requested by the terminal.

A distribution control method according to a third aspect of the present invention comprises:
by a computer, storing a content map representing a content held by a plurality of cache servers in a storage device of the computer, each of the plurality of cache servers being connected to at least one of a plurality of packet forwarding devices that forward a packet supplied from a content distribution server and temporarily holding a content;
extracting, when the computer receives a request for a content from a terminal, a cache server near the terminal from among the plurality of cache servers based on information about an area in which the terminal exists; and
instructing the extracted cache server to transmit the content requested by the terminal.

The present invention provides the following advantage, but not restricted thereto. A distribution system, a distribution control device, and a distribution control method according to the present invention can prevent a decrease of user QoE even when the traffic is increased in a content distribution system.

### BRIEF DESCRIPTION OF THE DRAWINGS

FIG. 1 is a block diagram illustrating a configuration of a distribution system according to a first exemplary embodiment.

FIG. 2 is a block diagram illustrating a configuration of a distribution system according to a second exemplary embodiment.

FIG. 3 is a block diagram illustrating a configuration of a cache server in the distribution system according to the second exemplary embodiment.

FIG. 4 is a block diagram illustrating a configuration of a distribution control device in the distribution system according to the second exemplary embodiment.

FIG. 5 is a block diagram illustrating a configuration of a distribution system according to a third exemplary embodiment.

### PREFERRED MODES

In the present disclosure, there are various possible modes, which include the following, but not restricted thereto.

According to a first extended mode, the distribution system according to the above first aspect is provided.

Based on the distribution system according to a second extended mode, if the extracted cache server does not hold the content requested by the terminal, the distribution control device instructs the extracted cache server to acquire the content from another cache server.

Based on the distribution system according to a third extended mode, if the cache servers other than the extracted cache server do not hold the content requested by the terminal, the distribution control device instructs the extracted cache server to acquire the content from the content distribution server.

Based on the distribution system according to a fourth extended mode, the distribution control device redirects the terminal to the extracted cache server.

Based on the distribution system according to a fifth extended mode, the distribution control device notifies the terminal of an address of the extracted cache server.

Based on the distribution system according to a sixth extended mode, at least one of the plurality of the cache servers is connected to two or more of the plurality of packet forwarding devices.

Based on the distribution system according to a seventh extended mode, each of the plurality of cache servers notifies the distribution control device of a list of contents held thereby at a predetermined time interval.

Based on the distribution system according to an eighth extended mode, each of the packet forwarding devices is an SGSN (Serving General packet radio service Support Node) device, a GGSN (Gateway General packet radio service Support Node) device, or an SGSN/GGSN (serving/gateway General packet radio service Support Node) device (xGSN device) in a mobile packet network or is an S-GW (Serving Gateway) device or a P-GW (Packet Data Network (PDN) Gateway) device in a mobile EPC (Evolved Packet Core) network.

According to a ninth extended mode, the distribution control device according to the above second aspect is provided.

According to a tenth extended mode, the distribution control method according to the above third aspect is provided.

According to the present invention, since the content is distributed from a cache server near the terminal, instead of from a content distribution server, the content distribution distance can be shortened, compared to before. Thus, time required for the terminal to receive the content can be reduced, the delay time from a timing at which the terminal transmits a request for the content to a timing at which the terminal reproduces the content can be significantly shortened, and end user QoE can be significantly improved.

In addition, according to the present invention, even if the amount of packet traffic flowing through the network is significantly increased with an increase in the number of terminals and the capacity of contents, the traffic in the network is not congested. Thus, since delay or packet loss is not caused, the terminals do not experience problems with frozen image, interrupted voice, and the like.

In addition, according to the present invention, the content distribution server, the packet forwarding devices, and the like do not need to be enhanced constantly, in anticipation of an increase in the number of terminals and the amount of traffic. In addition, there is no need to modify the terminals, either.

### First Exemplary Embodiment

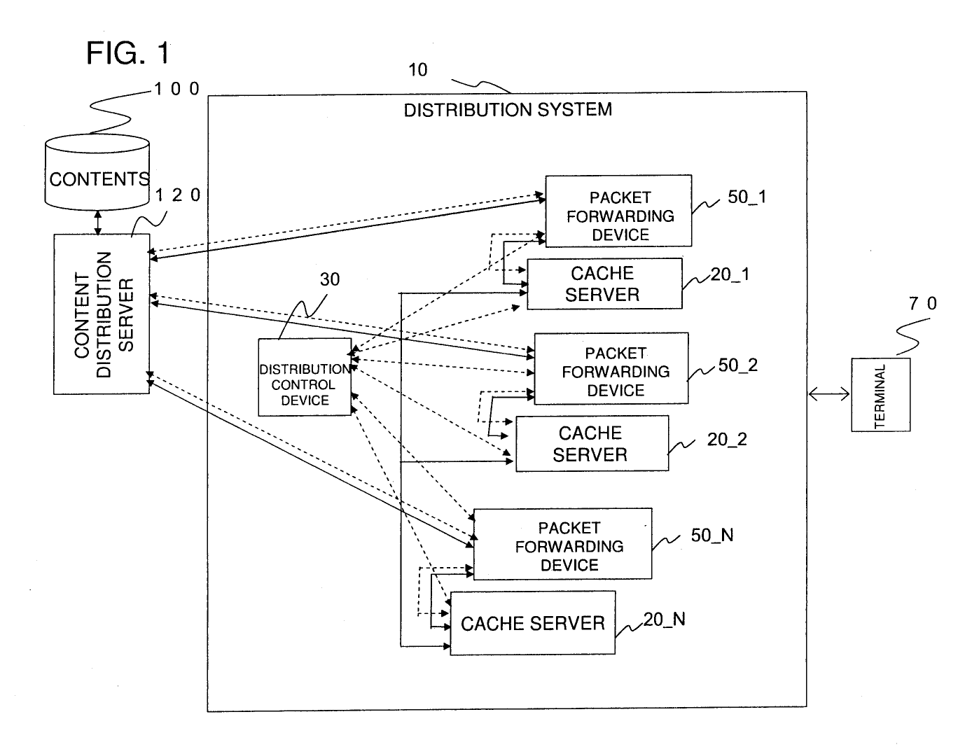

A distribution system according to a first exemplary embodiment will be described with reference to the drawings. FIG. 1 is a block diagram illustrating a configuration of a distribution system 10 according to the present exemplary embodiment.

In FIG. 1, the distribution system 10 includes a distribution control device 30, a plurality of packet forwarding devices 50_1 to 50_N, and a plurality of cache servers 20_1 to 20_N.

Each of the packet forwarding devices 50_1 to 50_N forwards packets supplied from a content distribution server 120.

Each of the cache servers 20_1 to 20_N is connected to at least one of the packet forwarding devices 50_1 to 50_N and temporarily holds a content.

The distribution control device 30 stores a content map representing the contents held by the individual cache servers 20_1 to 20_N. In addition, when the distribution control device 30 receives a request for a content from a terminal 70, the distribution control device 30 extracts a cache server near the terminal 70 from among the cache servers 20_1 to 20_N based on information about an area in which the terminal 70 exists and instructs the extracted cache server to transmit the content requested by the terminal 70.

It is preferable that, if the extracted cache server does not hold the content requested by the terminal 70, the distribution control device 30 instructs the extracted cache server to acquire the content from another cache server.

In addition, it is preferable that, if the cache servers other than the extracted cache server do not hold the content requested by the terminal 70, the distribution control device 30 instructs the extracted cache server to acquire the content from the content distribution server 120.

The distribution control device 30 may redirect the terminal 70 to the extracted cache server. The distribution control device 30 may notify the terminal 70 of an address of the extracted cache server.

At least one of the cache servers 20_1 to 20_N may be connected to two or more of the packet forwarding devices 50_1 to 50_N.

It is preferable that each of the cache servers 20_1 to 20_N notifies the distribution control device 30 of a list of contents held thereby at predetermined time intervals.

Each of the packet forwarding devices 50_1 to 50_N may be an SGSN (Serving General packet radio service Support Node) device or a GGSN (Gateway General packet radio service Support Node) device in a mobile packet network.

Each of the packet forwarding devices 50_1 to 50_N may be an S-GW (Serving Gateway) device or a P-GW (Packet Data Network (PDN) Gateway) device in a mobile EPC (Evolved Packet Core) network.

Based on the distribution system 10 according to the present exemplary embodiment, the content is distributed from a cache server near the terminal 70, not from the content distribution server 120. Namely, compared with conventional distribution systems, the content distribution distance can be shortened. Thus, time required for the terminal 70 to receive the content can be shortened, the delay time from a timing at which the terminal 70 transmits a request for the content to a timing at which the terminal reproduces the content can be significantly shortened, and end user QoE can be significantly improved.

In addition, based on the distribution system 10 according to the present exemplary embodiment, even if the amount of packet traffic flowing through the network is significantly increased with an increase in the number of terminals and the capacity of contents, the traffic in the network is not congested. Thus, since delay or packet loss is not caused, the terminals do not experience problems with frozen image, interrupted voice, and the like.

In addition, based on the distribution system 10 according to the present exemplary embodiment, the content distribution server 120, the packet forwarding devices 50_1 to 50_N, and the like do not need to be enhanced constantly, in anticipation of an increase in the number of terminals and the amount of traffic. In addition, there is no need to modify the terminal 70, either.

### Second Exemplary Embodiment

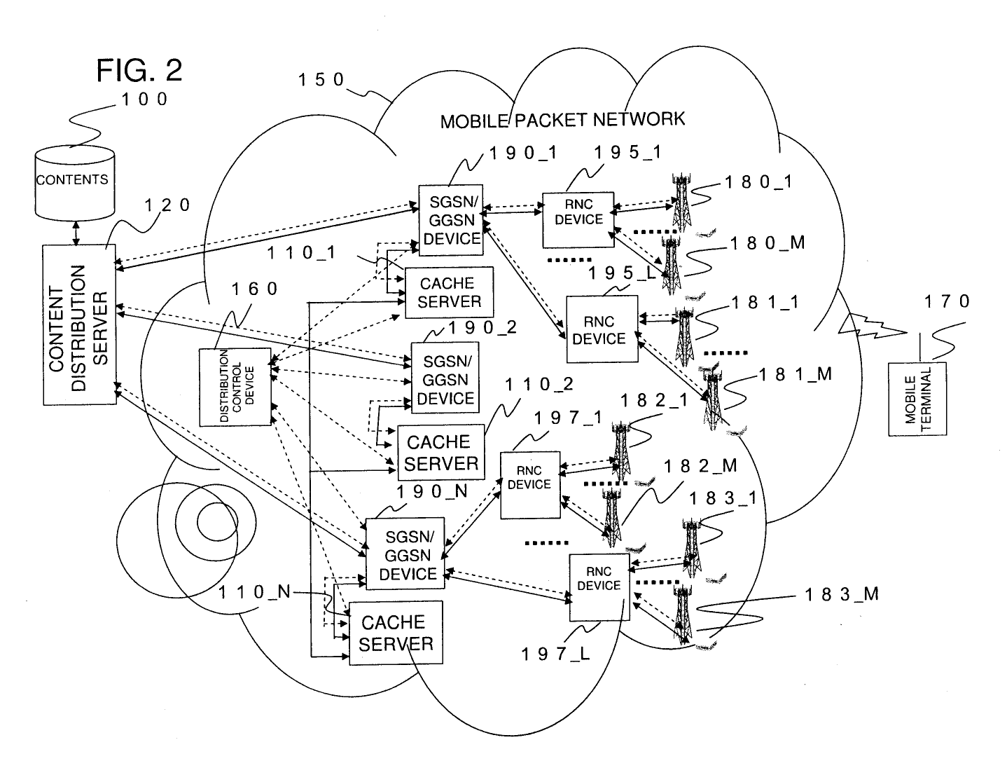

A configuration and an operation of a distribution system according to a second exemplary embodiment will be described with reference to FIGS. 2 to 4.

In the following exemplary embodiments, a moving image is used as a content. However, this is only an example. Even if the content is a still image, audio, voice, software, an application, or the like, the same configuration can be used.

FIG. 2 is a block diagram illustrating a configuration of a distribution system according to the present exemplary embodiment. In FIG. 2, a 3G (3rd Generation) mobile packet network is used as a network, and an SGSN/GGSN (serving/gateway General packet radio service Support Node) device is used as a packet forwarding device.

In FIG. 2, compressed-and-encoded bit streams of contents including at least one of a moving image, a still image, audio, and voice or files storing such compressed-and-encoded bit streams are stored as contents 100 in advance in a content distribution server 120.

SGSN/GGSN devices 190_1 to 190_N (N≧2) are arranged in the mobile packet network 150. The SGSN/GGSN device 190_1 is connected to RNC (Radio Network Controller) devices 195_1 to 195_L (L≧2), and the SGSN/GGSN device 190_N is connected to RNC devices 197_1 to 197_L.

While the SGSN/GGSN device 190_2 is also connected to L RNC devices, illustration of the RNC devices is omitted in FIG. 2. In addition, each of the RNC devices is connected to M base stations (M≧2). For example, the RNC device 195_1 is connected to M base station devices 180_1 to 180_M.

Each of the SGSN/GGSN devices is connected to a single cache server. For example, the SGSN/GGSN device 190_1 is connected to a cache server 110_1.

N cache servers 110_1 to 110_N are connected to each other. In addition, the N cache servers are connected to a single distribution control device 160.

When a mobile terminal 170 transmits a connection request message including the IP (Internet Protocol) address of the content distribution server 120, a base station in an area in which the mobile terminal 170 exists receives and transfers the connection request message to an RNC device managing the base station. In FIG. 2, one of the base stations 181_1 to 181_M receives and transfers such connection request message to the RNC device 195_L.

After receiving the connection request message from the base station, the RNC device stores the connection request message, the IP address of the content distribution server 120, the IP address of the mobile terminal 170, and the like in a payload portion of the GTP-U (GPRS Tunneling Protocol for User Plane) protocol. Next, the RNC device transfers a GTP-U packet to an SGSN/GGSN device managing the RNC device. In FIG. 2, after receiving the connection request message from the base station, the RNC device transfers a GTP-U packet to the SGSN/GGSN device 190_1 managing the RNC device 195_1 to 195_L.

Each of the SGSN/GGSN (serving/gateway General packet radio service Support Node) devices has a configuration in which an SGSN (Serving General packet radio service Support Node) device and a GGSN (Gateway General packet radio service Support Node) device are integrated with each other.

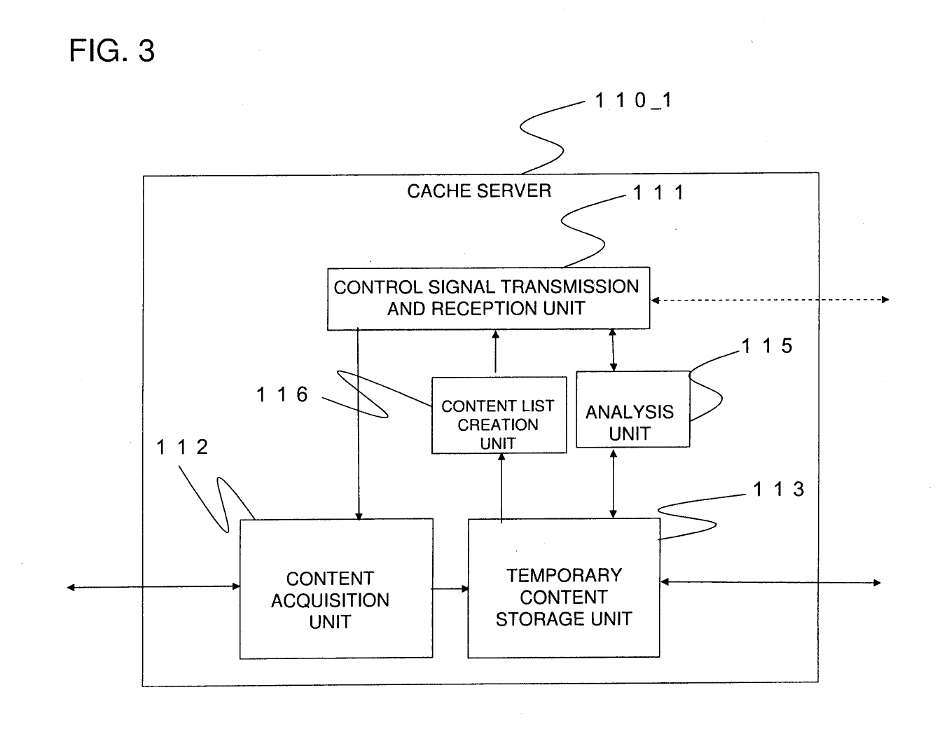

FIG. 3 is a block diagram illustrating a configuration of the cache server 110_1. A configuration of the cache server 110_1 connected to the SGSN/GGSN device 190_1 will be described with reference to FIG. 3. Since the other cache servers 110_2 to 110_N have the same configuration as that of the cache server 110_1, description thereof will be omitted.

In FIG. 3, the cache server 110_1 includes a control signal transmission and reception unit 111, an analysis unit 115, a temporary content storage unit 113, a content list creation unit 116, and a content acquisition unit 112.

The control signal transmission and reception unit 111 receives: the GTP-U packet storing the connection request message from the mobile terminal 170 and the IP addresses; and location information about the mobile terminal 170 from the SGSN/GGSN device 190_1 and outputs the data to the analysis unit 115.

The analysis unit 115 reads the connection request message stored in the payload portion of the GTP-U packet and outputs information such as the reception IP address of the mobile terminal 170 and the requested content to the distribution control device 160 via the control signal transmission and reception unit 111. In addition, the analysis unit 115 transmits the location information about the mobile terminal 170 to the distribution control device 160.

The temporary content storage unit 113 temporarily stores contents acquired from other cache servers or the content distribution server 120.

The content list creation unit 116 creates a content list of all the contents stored in the temporary content storage unit 113 at predetermined time intervals. In addition, the content list creation unit 116 transmits the content list to the distribution control device 160 via the control signal transmission and reception unit 111 at predetermined time intervals.

In accordance with a content acquisition notification supplied from the distribution control device 160 via the control signal transmission and reception unit 111, the content acquisition unit 112 reads a specified content from another cache server or the content distribution server 120 and stores the specified content in the temporary content storage unit 113.

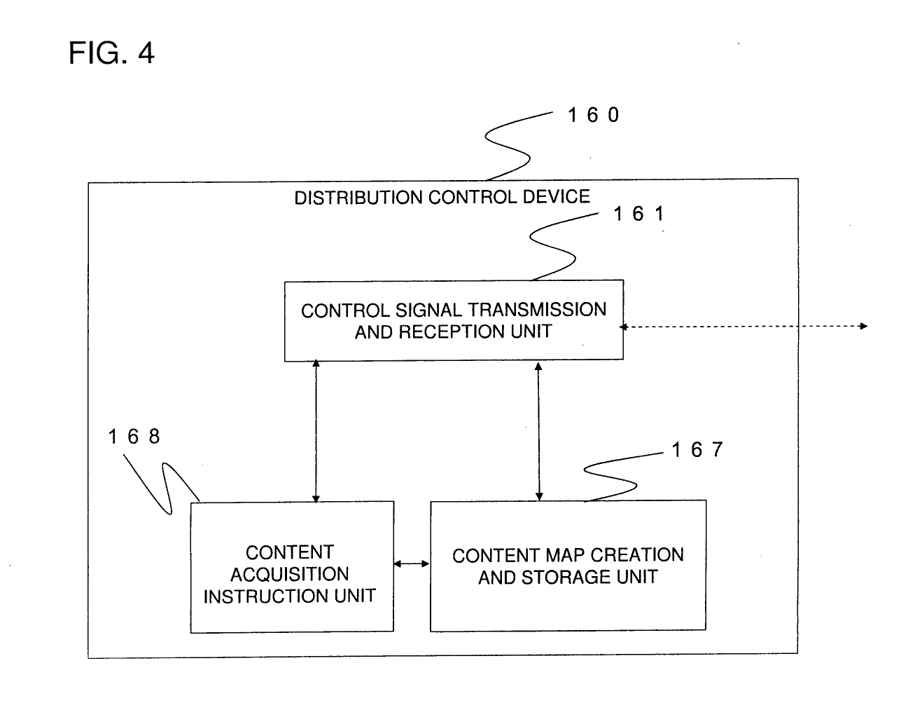

FIG. 4 is a block diagram illustrating a configuration of the distribution control device 160. A configuration of the distribution control device 160 will be described with reference to FIG. 4. In FIG. 4, the distribution control device 160 includes a control signal transmission and reception unit 161, a content acquisition instruction unit 168, and a content map creation and storage unit 167.

In FIG. 4, the control signal transmission and reception unit 161 is connected to and communicates with each of the cache servers 110_1 to 110_N. In the present exemplary embodiment, communication between the control signal transmission and reception unit 161 and the cache server 110_1 will be described as an example. Since communication between the control signal transmission and reception unit 161 and any one of the cache servers 110_2 to 110_N is the same as that between the control signal transmission and reception unit 161 and the cache server 110_1, repetitive description will be omitted.

The control signal transmission and reception unit 161 receives the reception IP address of the mobile terminal 170, the IP address of the content distribution server 120, information about the requested content, the location information about the mobile terminal 170, and the like from the cache server 110_1. Next, the control signal transmission and reception unit 161 outputs the data to the content acquisition instruction unit 168. In addition, at predetermined time intervals, the control signal transmission and reception unit 161 receives a content list from the cache server 110_1 and outputs the content list to the content map creation and storage unit 167.

At predetermined time intervals, the content map creation and storage unit 167 receives a content list from each of the cache servers 110_1 to 110_N to create and store a content map representing what contents are temporarily stored in each of the cache servers.

The content acquisition instruction unit 168 extracts a cache server physically close to the mobile terminal 170, based on the reception IP address of the mobile terminal 170, the information about the requested content, and the location information about the mobile terminal 170. In addition, the content acquisition instruction unit 168 gives an instruction to the mobile terminal 170 via the control signal transmission and reception unit 161, the cache server, and the SGSN/GGSN device. In accordance with this instruction, the mobile terminal 170 is redirected to the extracted cache server.

In addition, the content acquisition instruction unit 168 reads the content map from the content map creation and storage unit 167 and determines whether the content requested by the mobile terminal 170 is temporarily stored in the extracted cache server. If the content requested by the mobile terminal 170 is stored in the extracted cache server, the content acquisition instruction unit 168 does not give a notification to the extracted cache server.

However, if the content requested by the mobile terminal 170 is not stored in the extracted cache server, the content acquisition instruction unit 168 reads the content map and determines whether the content requested by the mobile terminal 170 is stored in any one of the cache servers other than the extracted cache server. The content acquisition instruction unit 168 outputs a content acquisition notification to the extracted cache server via the control signal transmission and reception unit 161.

The content acquisition notification includes the following first and second notifications. The first notification represents the IP address of a cache server in which the requested content is stored, and the second notification represents an instruction for acquiring the content. If the requested content is not stored in any one of the other cache servers, the first notification represents the IP address of the content distribution server 120, instead of the cache server IP address.

In FIG. 2, a single cache server is connected to a single SGSN/GGSN device. However, a single cache server may be connected to a plurality of SGSN/GGSN devices.

In addition, in FIG. 2, an SGSN/GGSN device in which an SGSN device and a GGSN device are integrated with each other is used. However, an SGSN device and a GGSN device may be arranged separately. In this way, a cache server can be connected to either the SGSN device or the GGSN device.

In addition, the mobile terminal 170 may be a mobile phone, a smartphone, or a PC including a data communication card. The mobile terminal 170 may be an arbitrary terminal, as long as the terminal can execute communication in a mobile 3G or 3.9G network.

### Third Exemplary Embodiment

A distribution system according to a third exemplary embodiment will be described with reference to the drawings.

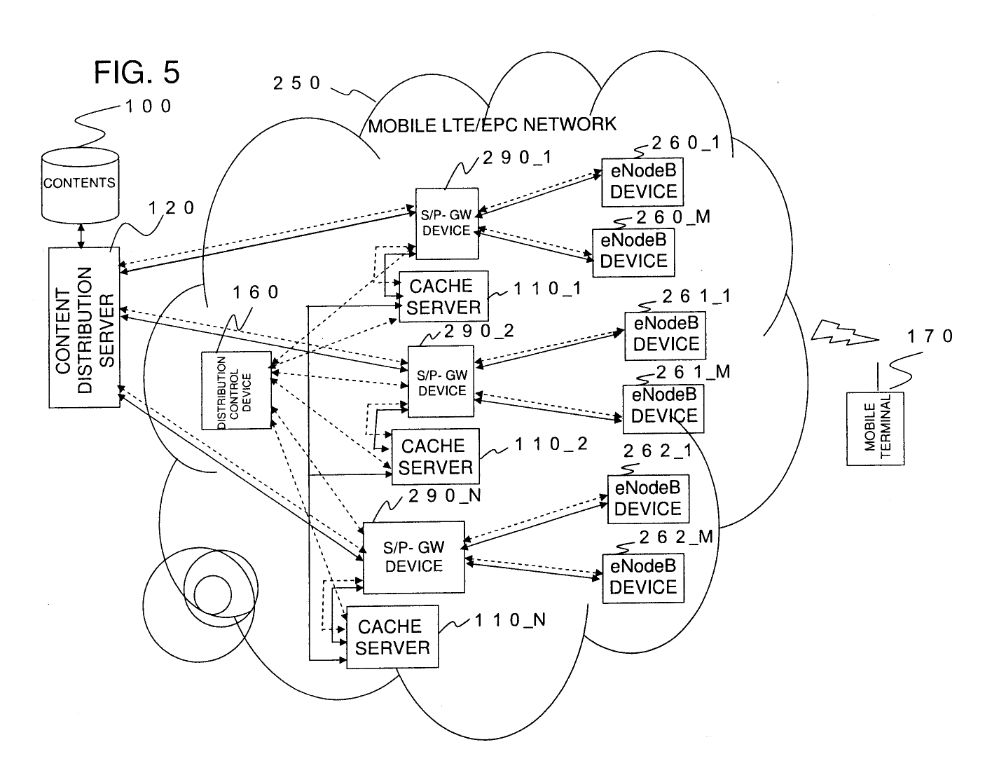

FIG. 5 is a block diagram illustrating a configuration of a distribution system according to the present exemplary embodiment. In FIGS. 2 and 5, the constituent elements denoted by the same reference characters operate in the same way, and repetitive description will be omitted.

In FIG. 5, instead of a 3G mobile network, LTE (Long Term Evolution)/EPC (Evolved Packet Core) network (a mobile LTE/EPC network 250), which is a 3.9G mobile network, is used as a mobile network. In addition, each S/P-GW device is used as a packet forwarding device. In LTE, functions of a base station device and an RNC device are unified into a single component and replaced by an eNodeB device.

In addition, in EPC, an S/P-GW (Serving/Packet Data-GateWay) device is connected to eNodeB devices. In this example, each of the S/P-GW (Serving/PDN Gateway) devices has a configuration in which an S-GW (Serving Gateway) device and a P-GW (Packet Data Network (PDN) Gateway) device are integrated with each other. In FIG. 5, M eNodeB devices are connected to a single S/P-GW device. For example, an S/P-GW device 290_1 is connected to eNodeB devices 260_1 to 260_M.

Each S/P-GW device is connected to a single cache server. For example, the S/P-GW device 290_1 is connected to the cache server 110_1.

When the mobile terminal 170 transmits a connection request message including the IP address of the content distribution server 120, an eNodeB device in an area in which the mobile terminal 170 exists receives the connection request message. In FIG. 5, one of the eNodeB devices 261_1 to 261_M receives the connection request message. One of the eNodeB devices 261_1 to 261M stores the connection request message, the IP address of the content distribution server 120, the IP address of the mobile terminal, and the like in the payload portion of the GTP-U protocol. Next, the eNodeB device transfers a GTP-U packet to an S/P-GW device 290_2.

The cache server 110_1 has a configuration illustrated in FIG. 3. In the present exemplary embodiment, the control signal transmission and reception unit 111 is connected to the S/P-GW device 290_1. Thus, the control signal transmission and reception unit 111 receives: the GTP-U packet storing the connection request message from the mobile terminal 170 and the IP addresses; and location information about the mobile terminal 170 from the S/P-GW device 290_1. The other cache servers 110_2 to 110_N execute the above communication with the S/P-GW devices connected thereto, respectively.

In the present exemplary embodiment, the content distribution server 120 is connected to the S/P-GW devices 290_1 to 290_N.

In FIG. 5, a single cache server is connected to a single S/P-GW device. However, a single cache server may be connected to a plurality of S/P-GW devices.

In addition, in FIG. 5, an S/P-GW device in which an S-GW device and a P-GW device are integrated with each other is used. However, an S-GW device and a P-GW device may be arranged separately. In this way, a cache server can be connected to either the S-GW device or the P-GW device.

In addition, the mobile terminal 170 may be a mobile phone, a smartphone, or a PC including a data communication card. The mobile terminal 170 may be an arbitrary terminal, as long as the terminal can execute communication in a mobile 3G or 3.9G network.

According to the above first to third exemplary embodiments, a plurality of cache servers are arranged near packet forwarding devices in a mobile network, contents are temporarily held in the cache servers, and the cache servers are connected to each other. In addition, a distribution control device for controlling the plurality of cache servers is arranged. This distribution control device uses information about an area in which a terminal exists, to connect the terminal to a cache server physically close to the terminal and instructs the cache server to distribute a content to the terminal. If a requested content is not stored in the cache server physically close to the terminal, the distribution control device gives an instruction to acquire the content from a nearby cache server. If the content is not stored in the nearby cache server, the content is acquired from a content distribution server and the content is distributed to the terminal. As a result, the following first to third meritorious effects can be provided.

First, since the content is distributed from a cache server near the terminal, instead of from a content distribution server, the content distribution distance can be shortened, compared to before. Thus, time required for the terminal to receive the content can be reduced, the delay time from a timing at which the terminal transmits a request for the content to a timing at which the terminal reproduces the content can be significantly shortened, and end user QoE can be significantly improved.

Second, even if the amount of packet traffic flowing through the network is significantly increased with an increase in the number of terminals and the capacity of contents, the traffic in the network is not congested. Thus, since delay or packet loss is not caused, the terminals do not experience problems with frozen image, interrupted voice, and the like.

Third, the content distribution server, the packet forwarding devices, and the like do not need to be enhanced constantly, in anticipation of an increase in the number of terminals and the amount of traffic. In addition, there is no need to modify the terminals, either.

Modifications and adjustments of the exemplary embodiment are possible within the scope of the overall disclosure (including the claims) of the present invention and based on the basic technical concept of the present invention. Various combinations and selections of various disclosed elements (including each element of each claim, each element of each exemplary embodiment, each element of each drawing, etc.) are possible within the scope of the claims of the present invention. That is, the present invention of course includes various variations and modifications that could be made by those skilled in the art according to the overall disclosure including the claims and the technical concept.

While at least one of or all of the above exemplary embodiments can be described as the following notes, the present invention is not limited thereto.

(Note 1) A distribution system, comprising:
a plurality of cache servers that are connected to at least one of a plurality of packet forwarding devices forwarding a packet supplied from a content distribution server and temporarily hold a content; and
a distribution control device that stores a content map representing a contents held by each of the plurality of cache servers, extracts, when receiving a request for a content from a terminal, a cache server near the terminal from among the plurality of cache servers based on information about an area in which the terminal exists, and instructs the extracted cache server to transmit the content requested by the terminal.

(Note 2) The distribution system according to note 1, wherein
if the extracted cache server does not hold the content requested by the terminal, the distribution control device instructs the extracted cache server to acquire the content from another cache server.

(Note 3) The distribution system according to note 2, wherein
if the cache servers other than the extracted cache server do not hold the content requested by the terminal, the distribution control device instructs the extracted cache server to acquire the content from the content distribution server.

(Note 4) The distribution system according to any one of notes 1 to 3, wherein
the distribution control device redirects the terminal to the extracted cache server.

(Note 5) The distribution system according to any one of notes 1 to 3, wherein
the distribution control device notifies the terminal of an address of the extracted cache server.

(Note 6) The distribution system according to any one of notes 1 to 5, wherein
the distribution control device is arranged as at least one of the plurality of cache servers, or arranged separately from the plurality of the cache servers.

(Note 7) The distribution system according to any one of notes 1 to 6, wherein
at least one of the plurality of the cache servers is connected to two or more of the plurality of packet forwarding devices.

(Note 8) The distribution system according to any one of notes 1 to 7, wherein
each of the plurality of cache servers notifies the distribution control device of a list of contents held thereby at a predetermined time interval.

(Note 9) The distribution system according to any one of notes 1 to 8, wherein
the plurality of cache servers are connected to each other.

(Note 10) The distribution system according to any one of notes 1 to 9, wherein
each of the packet forwarding devices is an SGSN (Serving General packet radio service Support Node) device, a GGSN (Gateway General packet radio service Support Node) device, or an SGSN/GGSN (serving/gateway General packet radio service Support Node) device in a mobile packet network or is an S-GW (Serving Gateway) device or a P-GW (Packet Data Network (PDN) Gateway) device in a mobile EPC (Evolved Packet Core) network.

(Note 11) The distribution system according to any one of notes 1 to 10, wherein
the content comprises at least one of a moving image, a still image, voice, audio, software, and an application.

(Note 12) The distribution system according to any one of notes 1 to 11, wherein the terminal is at least one of a mobile phone, a smartphone, a PC (Personal Computer) including a communication card, and a game machine including a communication card.

(Note 13) A distribution control device, comprising:
a content map creation and storage unit that stores a content map representing a content held by a plurality of cache servers, each of the plurality of cache servers being connected to at least one of a plurality of packet forwarding devices forwarding a packet supplied from a content distribution server and temporarily holding a content; and
a content acquisition instruction unit that extracts, when receiving a request for a content from a terminal, a cache server near the terminal from among the plurality of cache servers based on information about an area in which the terminal exists, and instructs the extracted cache server to transmit the content requested by the terminal.

(Note 14) The distribution control device according to note 13, wherein
if the extracted cache server does not hold the content requested by the terminal, the content acquisition instruction unit instructs the extracted cache server to acquire the content from another cache server.

(Note 15) The distribution control device according to note 14, wherein
if the cache servers other than the extracted cache server do not hold the content requested by the terminal, the content acquisition instruction unit instructs the extracted cache server to acquire the content from the content distribution server.

(Note 16) The distribution control device according to any one of notes 13 to 15, wherein
the content acquisition instruction unit redirects the terminal to the extracted cache server.

(Note 17) The distribution control device according to any one of notes 13 to 15, wherein
the content acquisition instruction unit notifies the terminal of an address of the extracted cache server.

(Note 18) A distribution control method, comprising:
by a computer, storing a content map representing contents held by a plurality of cache servers in a storage device of the computer, each of the plurality of cache servers being connected to at least one of a plurality of packet forwarding devices that forward a packet supplied from a content distribution server and temporarily holding a content;
extracting, when the computer receives a request for a content from a terminal, a cache server near the terminal from among the plurality of cache servers based on information about an area in which the terminal exists; and
instructing the extracted cache server to transmit the content requested by the terminal.

(Note 19) The distribution control method according to note 18, comprising:
if the extracted cache server does not hold the content requested by the terminal, instructing the extracted cache server to acquire the content from another cache server.

(Note 20) The distribution control method according to note 19, comprising:
if the cache servers other than the extracted cache server do not hold the content requested by the terminal, instructing the extracted cache server to acquire the content from the content distribution server.

(Note 21) The distribution control method according to any one of notes 18 to 20, comprising:
redirecting the terminal to the extracted cache server.

(Note 22) The distribution control method according to any one of notes 18 to 20, comprising:
notifying the terminal of an address of the extracted cache server.

(Note 23) A program, causing a computer to execute:
storing a content map representing a content held by a plurality of cache servers in a storage device, each of the plurality of cache servers being connected to at least one of a plurality of packet forwarding devices that forward a packet supplied from a content distribution server and temporarily holding a content;
extracting, when a request for a content is supplied from a terminal, a cache server near the terminal from among the plurality of cache servers based on information about an area in which the terminal exists; and
instructing the extracted cache server to transmit the content requested by the terminal.

(Note 24) The program according to note 23, wherein
if the extracted cache server does not hold the content requested by the terminal, the program causes the computer to execute instructing the extracted cache server to acquire the content from another cache server.

(Note 25) The program according to note 24, wherein
if the cache servers other than the extracted cache server do not hold the content requested by the terminal, the program causes the computer to execute instructing the extracted cache server to acquire the content from the content distribution server.

(Note 26) The program according to any one of notes 23 to 25, wherein the program causes the computer to execute redirecting the terminal to the extracted cache server.

(Note 27) The program according to any one of notes 23 to 25, wherein the program causes the computer to execute notifying the terminal of an address of the extracted cache server.

(Note 28) A computer-readable recording medium, storing the program according to any one of claims 23 to 27.

### REFERENCE SIGNS LIST

10 distribution system
20_1 to 20_N, 110_1 to 110_N cache server
30, 160 distribution control device
50_1 to 50_N packet forwarding device
70 terminal
100 contents
111 control signal transmission and reception unit
112 content acquisition unit
113 temporary content storage unit
115 analysis unit
116 content list creation unit
120 content distribution server
150 mobile packet network
161 control signal transmission and reception unit
167 content map creation and storage unit
168 content acquisition instruction unit
170 mobile terminal
180_1 to 180_M, 181_1 to 181_M, 182_1 to 182_M, 183_1 to 183_M base station device
190_1 to 190_N SGSN/GGSN device (xGSN device)
195_1 to 195_L, 197_1 to 197_L RNC device
250 mobile LTE/EPC network
260_1 to 260_M, 261_1 to 261_M, 262_1 to 262_MeNodeB device

1. A distribution system, comprising:
a plurality of cache servers that are connected to at least one of a plurality of packet forwarding devices forwarding a packet supplied from a content distribution server and each temporarily hold a content; and
a distribution control device that stores a content map representing a content held by the each of the plurality of cache servers, extracts, when receiving a request for a content from a terminal, a cache server near the terminal from among the plurality of cache servers based on information about an area in which the terminal exists, and instructs the extracted cache server to transmit the content requested by the terminal.

2. The distribution system according to claim 1, wherein
if the extracted cache server does not hold the content requested by the terminal, the distribution control device instructs the extracted cache server to acquire the content from another cache server.

3. The distribution system according to claim 2, wherein
if the cache servers other than the extracted cache server do not hold the content requested by the terminal, the distribution control device instructs the extracted cache server to acquire the content from the content distribution server.

4. The distribution system according to claim 1, wherein
the distribution control device redirects the terminal to the extracted cache server.

5. The distribution system according to claim 1, wherein
the distribution control device notifies the terminal of an address of the extracted cache server.

6. The distribution system according to claim 1, wherein
the distribution control device is arranged as at least one of the plurality of cache servers, or arranged separately from the plurality of cache servers.

7. The distribution system according to claim 1, wherein
at least one of the plurality of the cache servers is connected to two or more of the plurality of packet forwarding devices.

8. The distribution system according to claim 1, wherein
each of the plurality of cache servers notifies the distribution control device of a list of contents held thereby at a predetermined time interval.

9. The distribution system according to claim 1, wherein
the plurality of cache servers are connected to each other.

10. The distribution system according to claim 1, wherein
each of the packet forwarding devices is an SGSN (Serving General packet radio service Support Node) device, a GGSN (Gateway General packet radio service Support Node) device, or an SGSN/GGSN (serving/gateway General packet radio service Support Node) device in a mobile packet network, or is an S-GW (Serving Gateway) device or a P-GW (Packet Data Network (PDN) Gateway) device in a mobile EPC (Evolved Packet Core) network.

11. The distribution system according to claim 1, wherein
the content comprises at least one of a moving image, a still image, voice, audio, software, and an application.

12. The distribution system according to claim 1, wherein
the terminal is at least one of a mobile phone, a smartphone, a PC (Personal Computer) including a communication card, and a game machine including a communication card.

13. A distribution control device, comprising:
a content map creation and storage unit that stores a content map representing a content held by a plurality of cache servers, each of the plurality of cache servers being connected to at least one of a plurality of packet forwarding devices forwarding a packet supplied from a content distribution server and temporarily holding a content; and
a content acquisition instruction unit that extracts, when receiving a request for a content from a terminal, a cache server near the terminal from among the plurality of cache servers based on information about an area in which the terminal exists, and instructs the extracted cache server to transmit the content requested by the terminal.

14. The distribution control device according to claim 13, wherein
if the extracted cache server does not hold the content requested by the terminal, the content acquisition instruction unit instructs the extracted cache server to acquire the content from another cache server.

15. The distribution control device according to claim 14, wherein
if the cache servers other than the extracted cache server do not hold the content requested by the terminal, the content acquisition instruction unit instructs the extracted cache server to acquire the content from the content distribution server.

16. The distribution control device according to claim 13, wherein
the content acquisition instruction unit redirects the terminal to the extracted cache server.

17. The distribution control device according to claim 13, wherein
the content acquisition instruction unit notifies the terminal of an address of the extracted cache server.

18. A distribution control method, comprising:
by a computer, storing a content map representing a content held by a plurality of cache servers in a storage device of the computer, each of the plurality of cache servers being connected to at least one of a plurality of packet forwarding devices that forward a packet supplied from a content distribution server and temporarily holding a content;
extracting, when the computer receives a request for a content from a terminal, a cache server near the terminal from among the plurality of cache servers based on information about an area in which the terminal exists; and
instructing the extracted cache server to transmit the content requested by the terminal.

19. The distribution control method according to claim 18, comprising:
if the extracted cache server does not hold the content requested by the terminal, instructing the extracted cache server to acquire the content from another cache server.

20. The distribution control method according to claim 19, comprising:
if the cache servers other than the extracted cache server do not hold the content requested by the terminal, instructing the extracted cache server to acquire the content from the content distribution server.

21. The distribution control method according to claim 18, comprising:
redirecting the terminal to the extracted cache server.

22. The distribution control method according to claim 18, comprising:
notifying the terminal of an address of the extracted cache server.

23-28. (canceled)
